(19) United States
(12) Patent Application Publication
(10) Pub. No.: US 2006/0178834 A1
(43) Pub. Date: Aug. 10, 2006

(54) Systems and methods for optimizing crop yield with amino acid chelates and complexes

(76) Inventors: Deanna M. Brewer, Cincinnati, OH (US); Kevin L. Dickinson, Layton, UT (US)

Correspondence Address: KENNETH HORTON;KIRTON & MCCONKIE, P.O. BOX 45120, SALT LAKE CITY, UT, 84145-0120, US

(21) Appl. No.: 11/053,142

(22) Filed: Feb. 8, 2005

(51) Int. Cl. G06F 19/00

(52) U.S. Cl. 702/19

(57) ABSTRACT

Systems and methods for optimizing crop yield using amino acid chelates by comparing a crop with collected data about the desired amount of minerals that should be present are described. The system of the invention contains a database with data about the amount and type of minerals for optimum growth of a wide variety of plants. The system operates in a computing environment with input and output mechanisms allowing external users to input their own independent analysis data and/or access the database. The method of the invention is practiced by the user/farmer submitting samples for analysis (or just the analysis data), using the system to compare that analysis with the data in the system, the system providing a recommendation, and then the user/farmer applying the recommended amount of the mineral(s) (in the form of an amino acid chelate compound).

### FIELD OF THE INVENTION

The invention generally relates to systems and methods for optimizing crop yield. In particular, this invention relates to methods and systems for optimizing crop yield using minerals. More particularly, this invention relates to web-based methods and systems for optimizing crop yield by comparing a crop with collected data about the optimum amount of minerals that should be present in the crop.

### BACKGROUND OF THE INVENTION

It has been known in the art that amino acid chelates and amino acid complexes (hereafter “amino acid chelate compounds”) promote plant growth and function in combination with other substances in promoting the health of plants. See, for example, U.S. Pat. Nos. 3,969,540, 4,020,158, 4,076,803, 4,103,003, 4,167,564, 4,169,716, 4,169,717, 4,172,072, 4,201,793, 4,216,143, 4,216,144, 4,491,464, 4,599,152, 4,725,427, 4,774,089, 4,830,716, 4,863,898, 5,162,369, 5,292,538, 5,292,729, 5,516,925, 5,596,016, 5,614,553, 5,882,685, 5,888,553, 6,114,379, 6,159,530, 6,166,071, 6,207,204, 6,294,207, 6,299,914, 6,407,138, 6,426,424, 6,458,981, 6,518,240, 6,706,904, 6,710,079, and 6,716,814, the disclosures of which are incorporated herein by reference. The amino acid chelate compounds typically contain certain types of minerals (“mineral amino acid chelate compounds”).

The mineral amino acid chelate compounds have been used to promote the health and optimize crop yield in usually one of two methods. The first method is usually performed by estimation of a user. The user (i.e., farmer) uses his experience to determine the amount and type of mineral amino acid chelate compound(s) to apply to crop.

The second method of optimizing crop yield has been to collect data on the type and amount of a given mineral amino acid chelate compound to apply to a particular plant. The data is gathered and then used to statistically predict the amount of the mineral amino acid chelate compound(s) that the user should apply to the desired plant. See, for example, Canadian Patent No. 1,163,454, the entire disclosure of which is hereby incorporated by reference.

This second method of optimizing crop yield unfortunately has several drawbacks. The first drawback is that it has limited applicability. The known method for collecting and comparing the data is not user friendly, i.e., the recommendation is made and issued via a written mechanism. The second drawback is that it is heavily dependent on the technology used to develop and operate the statistical prediction, technology which has been inefficient and often difficult to use. The third drawback is that the data and statistical prediction are only accessed by the operator when making the recommendation and it is therefore not directly or indirectly accessible to the user.

### SUMMARY OF THE INVENTION

The invention relates to systems and methods for optimizing crop yield using mineral amino acid chelate compound(s). The system of the invention contains a database with data about the amount and type of minerals for optimum growth of a wide variety of plants. The system operates in a computing environment with input and output mechanisms allowing external users to input their own independent analysis data and/or access the database. The method of the invention is practiced by the user/farmer submitting samples for analysis (or just the analysis data), using the system to compare that analysis with the data in the system, using the system to provide a recommendation, and then the user/farmer applying the recommended amount of the mineral(s) in the form of an amino acid chelate compound.

### BRIEF DESCRIPTION OF THE FIGURES

The following description of the invention can be understood in light of the Figures, in which:

FIG. 1 illustrates a flowchart depicting the method in one aspect of the invention; and

FIGS. 2a and 2b depict an interface between the system and user in one aspect of the invention.

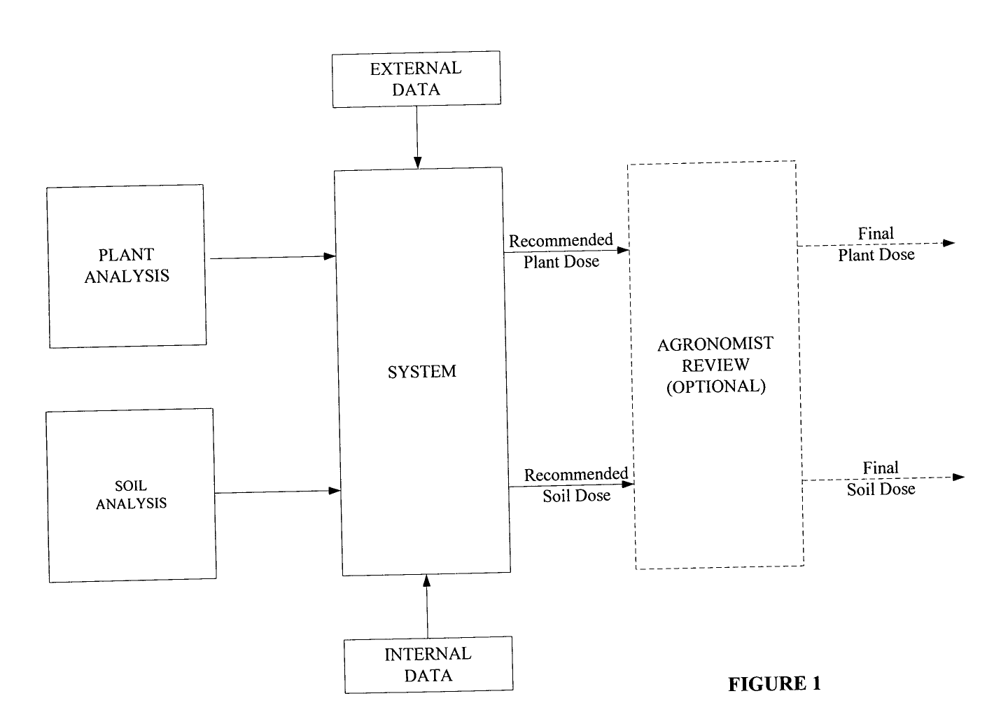

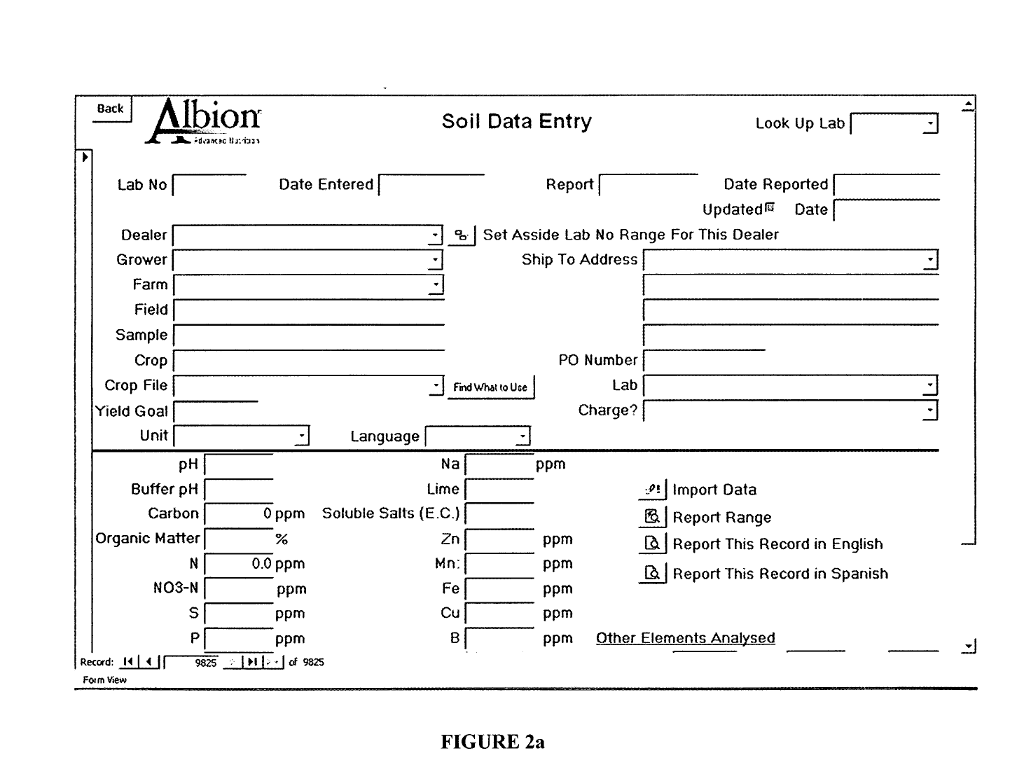

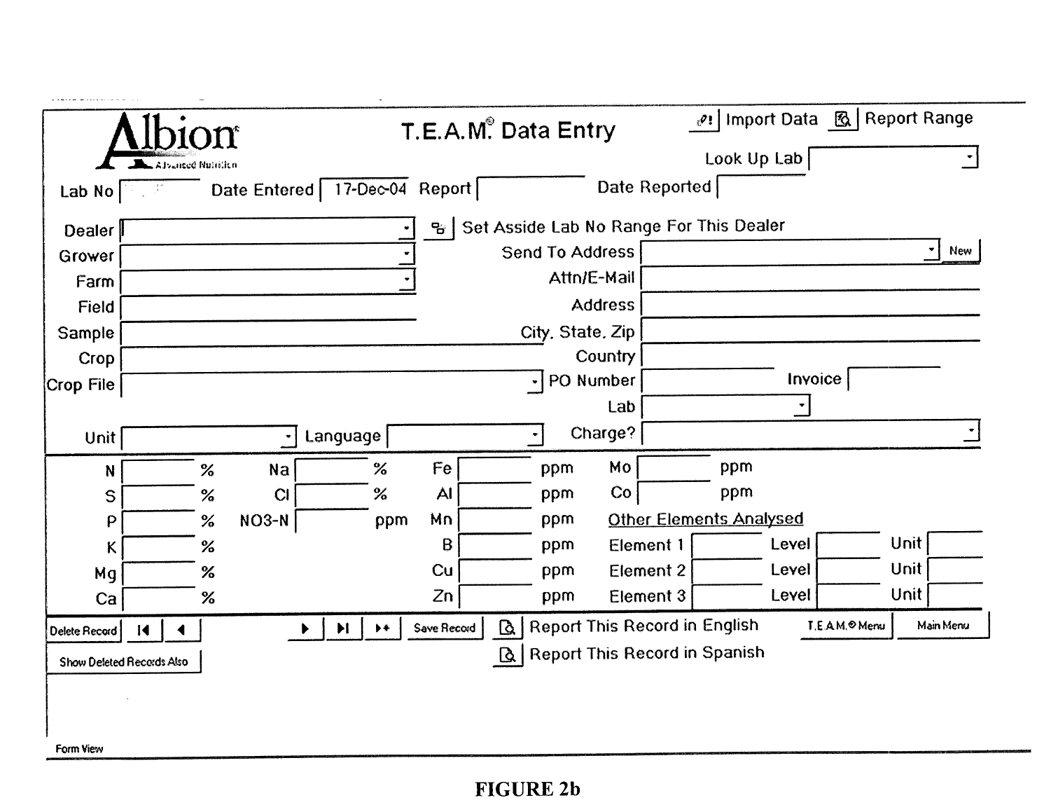

FIGS. 1, 2a, and 2b presented in conjunction with this description are views of only particular—rather than complete—portions of the compositions and methods of making and using the compositions according to the invention. Together with the following description, the Figures demonstrate and explain the principles of the invention. In the Figures, the thickness of layers and regions are exaggerated for clarity. The same reference numerals in different drawings represent the same element, and thus their descriptions will be omitted.

### DETAILED DESCRIPTION OF THE INVENTION

The following description provides specific details in order to provide a thorough understanding of the invention. The skilled artisan, however, would understand that the invention can be practiced without employing these specific details. Indeed, the invention can be practiced by modifying the illustrated system and method and can be used in conjunction with apparatus and techniques conventionally used in the industry. The invention described below deals primarily with minerals applied as amino acid chelates and/or complexes for optimization of crop yield. The invention, however, could be modified for other uses, such as optimization of crop yield using other chemical compounds, including minerals that are neither chelated nor complexed with amino acids like nitrogen, sulfur, phosphate, potash, lime, and gypsum. As well, the invention could be modified for other uses, such as improving plant health appearance, evaluating water, fertilizer, and/or animal feed.

This invention includes systems and methods for optimizing crop yield or improving plant health by determining the optimum amount of a mineral (in the form of an amino acid chelate compound) to apply to the plants or soil of the crop. The method is practiced by analyzing the plants and soil, comparing the results of that analysis with standardized data to determine the recommended (i.e., optimum) amount of the mineral amino acid chelate compound(s) to apply to the plant and/or the soil, and then applying that recommended amount of that mineral amino acid chelate compound(s) to the plant and/or soil. The system of the invention contains the standardized data in the form of a database in a computing environment that can be accessible to individual users/farmers.

In one aspect of the invention, and as depicted in FIG. 1, the method of the invention begins by compiling a database containing the data needed to optimize the crop yield. The data collected generally comprises any information that is relevant to the amount of minerals in plants and/or the amount of amino acid chelated and/or complexed form of the mineral that will improve the growth or health of a given plant. In one aspect of the invention, the data collected includes the given mineral profile of the plant and/or soil that produces a maximum yield of that plant. The mineral profile is specific to each species of plant and contains not only the amount of mineral in the tissue of that species, but also the ratio or relationship of the various minerals to each other. The mineral profile for any given plant species may be impacted by several parameters, including geographical location, growing season, climatic conditions, excessive dry spells, excessive heat, insufficient heat, excessive rainfall, humidity, or a combination thereof. When analyzing a plant for the mineral profile, it is important that the measurement be taken from—and later compared to—the same portion of the plant to make a valid comparison.

Soil quality can also be an important factor in stimulating plant growth and development. The soil for each plant species has a different requirement for optimal growth of that plant. Therefore, a soil analysis can also be made to determine the mineral profile in the soil.

The data that will be compiled into the database can be obtained from either internal information sources or external information sources. With internal information sources, all data existing in the owner's operations is collected, including data such as lists, experiments, or the like.

For external data sources, any data that is external to the owner's operation, including data such as lists or handbooks is collected. Examples of external data are described, for example, in Canadian Patent No. 1,163,454, the disclosure of which is incorporated herein by reference. Both of the external and internal sources of information are then collected and compiled into a database.

The next step of the method includes analyzing the plant or soil to determine the existing mineral profile of the plant and/or soil. The plant analysis is a more direct and short term predictor of the factors needed to optimize crop yield. The soil analysis, however, is more of an indirect and long term predictor of the optimization of the crop yield.

The plant and/or soil are analyzed to determine the mineral profile, including the concentrations of the minerals and metals therein. While the concentration of any mineral or metal can be measured, it is generally desired to measure those minerals or metals which are known to impact the growth of the plant. In particular, the plant and/or soil can be measured for those minerals/metals that are contained in amino acid chelate compounds, and/or those which are contained in the database.

In one aspect, the method of the invention—and therefore the plant and/or soil analysis—can be performed more than one time during the growth cycle of the plant. It is known that the mineral profile of the plant/soil will change during the growth of the plant, especially under major stress conditions from extreme weather conditions, including extreme heat and/or cold, droughts, and the like. In one aspect of the invention, the plant and/or soil analysis are made at the stages described in Canadian Patent No. 1,163,454, the disclosure of which is incorporated herein by reference.

The plant analysis and/or soil analysis is then compared to the database that has been previously compiled. That database contains data representing the mineral profiles of mature plants produced at the desired or optimum crop yield. In one aspect of the invention, the desired yield and the optimum yield may not be the same, even though in most instances they will be substantially the same. The comparative data in the database takes into consideration the norms, standards, balances, and relationships of specific metals and certain non-metal minerals, as well as general region, and number of minerals which may be applied together.

The database contains a proprietary algorithm for performing the statistical comparison of the plant/soil analysis to the existing data. While the algorithms for comparing the measured pant/soil analysis with the statistical data can be formulated by anyone skilled in the art once the data has been collected, the database can contain algorithms that are nonetheless proprietary.

In one aspect of the method of the invention, a recommended dosage for the plant is obtained. This recommended dosage is based on the soil and/or plant analysis, comparative data, and proprietary algorithms. The recommended plant dosage contains the recommended amount of the mineral amino acid chelate compound(s) to be applied to the plant for optimum crop growth and/or to improve the plant health.

Optionally, a recommended dosage for the soil can be obtained. This recommended dosage is based on the soil and/or plant analysis, comparative data, and proprietary algorithms. The recommended soil dosage contains the recommended amount of the mineral amino acid chelate compound(s) to be applied to the soil for optimum crop growth and/or to improve the plant health.

Optionally, as shown by the dashed lines in FIG. 1, the recommended plant dose and recommended soil dose are then subjected to analysis by an agronomist to obtain a final recommended plant dose and a final recommended soil dose. The agronomist checks the recommended doses and adjusts them for factors that cannot be considered by the comparative data. Examples of such factors that the agronomist considers include climate, seasons, variety, soil conditions, and pest pressure. The agronomist analysis is often more important for the recommended soil dose than for the recommended plant dose.

Finally, the final plant and/or soil dose—or the recommended plant and/or soil dose when the agronomist review is not used—are then given to the user/farmer. The recommend or final dose(s) gives a recommendation of the specific amino acid chelate(s) and/or complex(es) containing the mineral or metal that should be applied to the plant and/or soil. The dose(s) can recommend any number of minerals that are needed by the plant and/or soil. In one aspect of the invention, the dose recommends at least one mineral amino acid chelate compound that can optimize the crop yield or improve the health of the plant. Examples of such amino acid chelates include those containing the minerals calcium, copper, iron, magnesium, manganese, and/or zinc, as well as amino acid complexes containing the minerals boron, potassium, phosphorus, and/or molybdenum, as well as those described in the patents mentioned above.

In aspect of the invention, the amount of the mineral in the plant/soil can be determined as deficient, very low, low, optimal, high, very high, or excessive. If the mineral is deficient, very low, or low, then additional mineral (by way of the mineral in the amino acid chelate compound) is recommended to be added so that mineral reaches the desired level. If the mineral is high, very high, or excessive, then other types of minerals are then added to adjust the balance of that mineral to the desired concentration. In another aspect of the invention, a scale (for example, of numbers +/−1-200 or similar criteria) can be assigned to the relationship between the actual and the desired concentration that is needed.

The mineral amino acid chelate compound(s) are then formulated and applied to the plant and/or soil as known in the art. The mineral amino acid chelate compound(s) can be formulated and applied as described in the above patents. In one aspect of the invention, they are formulated as powders and then applied in the form of liquid.

The invention also includes a system for optimizing the crop yield. The system of the invention is used to practice the above method while allowing the user/farmer to access the system. Accordingly, the system contains any components or elements that—when combined—allow the method described above to be practiced.

The system contains data in any electronic format that can be manipulated and used by the system to give a recommendation for the crop. In one aspect of the invention, a database is used to contain the data. The database is used as described above, i.e., in a statistical manner to give the recommended dose(s). As noted above, the database contains the data of the mineral profiles, any necessary algorithms (including any proprietary algorithms) that are used to give the recommended dose(s), as well as dealer information, grower/farmer information, locale, and the like. Any database known in the art that operates in the above manner can be used in this aspect of the invention, including Microsoft Access. In one aspect of the invention, Microsoft Access is used as the database in the system of the invention.

The system operates using any computer operating system that is compatible with the database that is selected. In one aspect of the invention, such as where Microsoft Access is used, the operating system that is used is Microsoft Windows. Of course, any other operating system that is compatible with Microsoft Access could be used in this aspect of the invention. Where other databases are used, other operating systems may be used in the invention. Examples of such other operating systems include Apple OS, Unix, and Linux.

The system of the invention can use any compatible computer programming language. In one aspect of the invention, where Microsoft Access and Windows is used, the computer language is Visual Basic for Applications (VBA). Of course, other computer languages and programming languages could be used that are compatible with the database and operating system chosen.

The system uses any known computer hardware capable of running the selected database, operating system, and computer language. Examples of such hardware include desktop personal computers, laptop computers, notebook computers, tablet personal computers, personal digital assistants (PDAs), workstations, and servers. In one aspect of the invention, a SQL Server is used as part of the hardware for the system.

The system for optimizing the crop yield of the plants can operate with or without direct external access provided to individual users. Without direct external access, the owner/operator of the system serves as an electronic intermediary between the system and the user/farmer. In other words, the user/farmer electronically gives the results of the plant and/or soil analysis to the owner/operator who then electronically gives the final recommended plant/soil dose back to the user/farmer.

With direct external access, the user/farmer has direct access to the database interface itself. The external access can be provided via any electronic system that interfaces with the database. In one aspect of the invention, the electronic system comprises the Internet.

The external access can be exemplified in the following mechanisms. In a first mechanism, the user obtains the plant and soil analysis and sends the information to the owner/operator of the system. The owner/operator then uses the system to give the recommended dose of the plant and soil dosage in a report. The report can be electronically mailed to the client and retrieved by the client through the electronic mail system. Alternatively, the report can be retrieved by the client directly accessing the system. The report can be issued in any electronic format that can be accessed by the user, including Adobe Acrobat (pdf), Jpeg (jpg), Microsoft Excel (xls), Microsoft Access (mdb), or delimited ANSI Text (txt or csv) formats. In one aspect of the invention, the report is provided in Adobe Acrobat format.

In a similar mechanism, the user obtains the plant and soil analysis and electronically sends the information to the owner/operator. The analysis can be sent in any electronic format that can be used by the owner/operator, including Adobe Acrobat (pdf), Jpeg (jpg), Microsoft Excel (xls), Microsoft Access (mdb), or delimited ANSI Text (txt or csv) formats. In one aspect of the invention, the analysis is provided in delimited ANSI Text (txt or csv) formats. The data is then uploaded into the system by the owner and the owner then uses the system to give the recommended dose of the plant and soil dosage in a report. The report can be electronically mailed to the client and retrieved by the client through the electronic mail system. Alternatively, the report can be retrieved by the client directly accessing the system.

In yet another mechanism, the external access is provided when the individual user/farmer performs the plant and soil analysis and then enters that analysis information directly into the system. The system then immediately returns the recommended dose for the plant and/or soil in a report which the individual user can then save in electronic format or immediately print.

The user can access the system using any suitable electronic device, whether in a fixed location, such as a computer terminal in laboratory, or in a portable location, such as using a portable electronic device. In one aspect of the invention, the user can provide the plant and/or soil analysis using a portable electronic device as described in U.S. Pat. Nos. 6,360,179 and 6,687,616, the disclosures of which are incorporated herein by reference.

Thus, the user can interact directly with the database of the system, i.e., by inputting the results soil and/or plant analysis. The system then uses that information to perform the analysis and immediately give the recommended dose(s) to the user. FIGS. 2 and 2b illustrate an example of one interface that can be used when the user accesses the system in this manner. In these Figures, the upper portion of the interface contains the identifying parameters that the user will input into the system, including information about the user and the type of plant. In the bottom portion of the interface, the user will input the results of the plant and/or soil analysis.

Both the upper portion and bottom portion of the interface can be modified to contain less or more parameters. The number (and type) of additional parameters depend on the needs of the user. For example, the interface illustrated in FIG. 2 could be modified to contain information about the climate, the season, the stage of plant growth, the age of the plant, additional information about the soil (i.e., the texture), more—or fewer—chemicals, the location of the plant/soil (i.e., the farm), the types and amounts of fertilizers used and when they were applied, and the like.

Once the information has been input, the user can request the system to calculate the recommended doses. In one aspect of the invention, the recommendation is calculated and then returned immediately. In another aspect of the invention, the preliminary recommendation is calculated and then given to an agronomist. Once the agronomist has performed the additional analysis, the final recommended dose(s) is then provided to the user. Both the input (plant/soil analysis) and the output (dose recommendation) can be electronically saved as an individual record in the database and given a unique identification number. See, for example, U.S. Pat. No. 6,745,127, the disclosure of which is incorporated herein by reference.

In one aspect of the invention, the system can be operated and accessed by portable electronic devices. In this aspect of the invention, the user can electronic access the system by any portable electronic device that is compatible with the system, including a WAP-enabled cell phone, wireless PDAs, laptop computers, notebook computers, or tablet personal computers.

The system can be modified and adapted as desired by the owner and/or user. For example, unusual recommendations can be flagged and automatically filtered through an agronomist. In another example, a portion of the database can be dedicated to any desired part of the data. In this example, a portion of the database could be dedicated to a specific plant and/or location (i.e., apples from Washington State) or a specific farmer. In another example, a portion of the database can be dedicated to feedback from the user/farmer comparing the actual growth of the plant to the expected growth of the plant based on the recommended dose.

The system could also contain any other component currently available for web-based systems. In one example, a portion of the system could be dedicated for information exchange between users having common interests, such as a forum or a blog. In another example, a portion of the system could be used for real-time information exchange between the owner and a user.

Having described the preferred aspects of the invention, it is understood that the invention defined by the appended claims is not to be limited by particular details set forth in the above description, as many apparent variations thereof are possible without departing from the spirit or scope thereof.

What is claimed is:

1. A method for improving plant health, comprising:
providing a database containing data about plant health;
analyzing a plant or soil to determine the content of a mineral; and
comparing the analysis with the database to determine a desired concentration of that mineral in the plant or soil.

2. The method of claim 1, further comprising applying an amount of that mineral to the plant or soil to change the mineral content of the plant or soil to substantially the desired concentration.

3. The method of claim 1, wherein the desired concentration is that concentration that improves the growth of the plant.

4. The method of claim 1, wherein the desired concentration is that concentration that provides the optimum growth of the plant.

5. The method of claim 1, wherein the database is electronically accessible to a user.

6. The method of claim 5, where the electronic access is provided by electronic mail or by the Internet.

7. The method of claim 1, wherein the data includes information about the mineral profile of a plant.

8. The method of claim 1, wherein the plant or soil analysis includes information about the mineral profile of that plant.

9. The method of claim 2, wherein the mineral is applied in the form of an amino acid chelate or an amino acid complex.

10. A method for improving plant health, comprising:
providing a database containing data about plant health;
analyzing a plant or soil to determine the content of a mineral;
electronically accessing to the database to compare the analysis with the database to determine a desired concentration of that mineral in the plant or soil; and
applying an amount of that mineral to the plant or soil to change the mineral content of the plant or soil to substantially the desired concentration.

11. The method of claim 10, wherein the desired concentration is that concentration that provides the optimum growth of the plant.

12. The method of claim 10, wherein the mineral is applied in the form of an amino acid chelate or an amino acid complex.

13. A system for improving plant health, comprising:
means for providing a database containing data about plant health;
means for analyzing a plant or soil to determine the content of a mineral; and
means for comparing the analysis with the database to determine a desired concentration of that mineral in the plant or soil.

14. A system for improving plant health, the system comprising:
means for managing data about plant health;
means for comparing the data to the measured concentration of a mineral in a plant or soil; and
means for electronically communicating that comparison.

15. The system of claim 14, further comprising means for recommending a concentration of that mineral that will enhance the health of the plant.

16. The system of claim 14, wherein the managing means comprises a database.

17. The system of claim 16, wherein the database is Microsoft Access.

18. The system of claim 14, wherein the communication means comprises electronic mail or the Internet.

19. A method for improving plant health, comprising
providing a system containing means for managing data about plant health, means for comparing the data to the measured concentration of a mineral in a plant or soil, and means for electronically communicating that comparison; and
using that system to recommend a concentration of that mineral that will enhance the health of the plant.

20. The method of claim 19, further comprising applying an amount of that mineral to the plant or soil to change the mineral concentration of the plant or soil to substantially the desired concentration.

21. The method of claim 19, wherein the desired concentration is that concentration that provides the optimum growth of the plant.

22. The method of claim 20, wherein the mineral is applied in the form of an amino acid chelate or an amino acid complex.

23. The method of claim 19, wherein the managing means comprises a database.
